(19) United States
(12) Patent Application Publication
(10) Pub. No.: US 2014/0317407 A1
(43) Pub. Date: Oct. 23, 2014

(54) INCREMENTAL MAC TAG GENERATION DEVICE, METHOD, AND PROGRAM, AND MESSAGE AUTHENTICATION DEVICE

(71) Applicant: NEC CORPORATION, Tokyo (JP)

(72) Inventor: Kazuhiko Minematsu, Minato-ku (JP)

(73) Assignee: NEC CORPORATION, Minato-ku, Tokyo (JP)

(21) Appl. No.: 14/353,349

(22) PCT Filed: Oct. 15, 2012
(86) PCT No.: PCT/JP2012/006586

§ 371 Date: Apr. 22, 2014

(30) Foreign Application Priority Data
Oct. 31, 2011 (JP) 2011-239232

(51) Int. Cl. H04L 9/32

(52) U.S. Cl. CPC H04L 9/3244
USPC 713/170

(57) ABSTRACT

Provided is an incremental MAC tag generation device that enables incremental tag calculations that can support the editing of all block units, without losing the efficiency of normal tag calculations. A padding unit (11) carries out padding on a final block of a plaintext (M) that has been divided into a plurality of blocks. A cache reference parallel encryption unit (12) inputs blocks of the plaintext (M) other than the final block, a cached plaintext (M′), and an intermediate variable (S′) obtained by encrypting the plaintext (M′), and calculates an intermediate variable (S). A scrambled hash unit (13) carries out scrambling processing and calculates a hash value V. A tag generation unit (14) encrypts the hash value V and calculates a tag.

### TECHNICAL FIELD

The present invention relates to an incremental MAC tag generation device, method, and program, and a message authentication device which are used for authenticating a message using a common key.

### BACKGROUND ART

An incremental Message Authentication Code (hereinafter, referred to as MAC) scheme is a scheme to guarantee whether a message is valid by applying a tag which only a person knowing a secret key can calculate to a message. When using the MAC scheme, for example, in communication between two users sharing a secret key, a tampering made by the third party during the communication can be detected.

Specifically, for example, when a secret key shared by a transmitter and a receiver of a message is K, a tag T=MAC(K, M) is calculated by applying a plaintext M and secret key K to an MAC function F with respect to the plaintext M. Furthermore, for example, when receiving a plaintext M′ and a tag T′, a receiver calculates a tag T″ from the plaintext M′ and a shared key K. Then, when the received tag T′ is matched with the calculated tag T″, the receiver determines that the plaintext M′ is received from a legitimate transmitter.

In a general MAC scheme, although a tag T=MAC(K, M) with respect to a certain plaintext M is previously calculated, there is a need to recalculate a tag with respect to another certain plaintext M′ from the beginning. Therefore, even when the plaintext M′ is obtained by changing a part of the plaintext M, it is difficult to speed up calculating a tag T′=MAC(K, M) corresponding to the plaintext M′ at high speed.

On the other hand, there is a scheme in which when a sent plaintext M′ is a message obtained by performing a specific editing process on a previously sent plaintext M, the tag T″ with respect to the plaintext M′ can be calculated at high speed by reusing a calculation result of a tag T with respect to the plaintext M. Such a MAC scheme is called “being incremental” (with respect to the processing).

In the incremental MAC scheme, the calculation result of the tag T is reused. Therefore, when messages partially or sequentially vary and when messages with a relatively small variation continue, the incremental MAC scheme may significantly reduce a calculation amount. As a detailed application example, the incremental MAC scheme is used for guaranteeing authenticity of a document on a computer and protecting a large-capacity memory from hacking in hardware such as a game machine.

A parallelizable MAC (PMAC) described in NPL 1 or an XORMAC described in NPL 2 is known as an example of the incremental MAC. The PMAC described in NPL 1 will now be explained. FIG. 8 is a block diagram illustrating an operation of a general tag generation device using a PMAC. It is assumed that an n-bit block cipher E(K, *) is a component. It is assumed that a message is M=(M[1], M[2], . . . , M[L]), each of blocks M[1], . . . , M[L−1] is n bits, and an M[L] is n bits or less. In this case, a tag T may be obtained as follows.

S[i]=E(K,f_{—}i(U)+M[i]) for i=1, . . . , L−1

S[L]=M[L] if |M[L]|=n,S[L]=M[L]∥0*otherwise

V=S[1]+S[1]+ . . . +S[L]

T=E(K,V+ff_{—}0(U)) if |M[L]|=n,T=E(K,V+ff_{—}1(U)) otherwise (Equation PMAC)

Herein, + represents a bit-by-bit exclusive OR (XOR). ∥ represents connection of bit sequences. |M[L]| represents a bit length of the final block M[L]. Furthermore, the E(K, M[i]) represents encryption of a plaintext M[i] according to a key K of a block cipher E, and U represents a ciphertext E(K, 0̂n) of a constant 0̂n (n-bit sequence of all zero). The function f_i represents a multiplication of an input value and a constant 2̂(i−1) in a finite field. The function ff_i (where i=0, 1) represents a multiplication of an input value and a constant 3̂(i+1) in a finite field. Also, the PMAC may be executed in parallel, unlike a general cipher block chaining-MAC (CBC-MAC).

As described above, in the PMAC, the incremental processing can be performed with respect to variation of the block. In this regard, when a certain block of the plaintext M′ is different from a corresponding block of a preset M, it is necessary to perform recalculation. For example, when (M=(M[1], M[2], . . . , M[L]), T=MAC(K, M)) is provided, a tag T′ of a plaintext M′ with a relationship of M′=(M′[1], M[2], . . . , M[L]), M′[1]≠M[1], is obtained by the following Equation.

V=D(K,T)+ff_{—}w(U)

V′=V+E(K,f_{—}1(U)+M[1])+E(K,f_{—}1(U)+M′[1])

T′=E(K,V′+ff_{—}w(U)) (Equation PMAC-inc)

D(K, *) is a decryption function of a block cipher. w (0 or 1) depends on a length of |M[L]|. Therefore, the recalculation requires only one-time decryption processing according to a block cipher and several-time encryption processing. In general, the cost of the recalculation is proportional to a hamming weight (difference) by block unit in an original message and a message to be processed.

### CITATION LIST

### Non Patent Literature

NPL 1: P. Rogaway. Efficient Instantiations of Tweakable Blockciphers and Refinements to Modes OCB and PMAC. Advances in Cryptology—ASIACRYPT'04. LNCS 3329, pp. 16-31, 2004.
NPL 2: M. Bellare, O. Goldreich, and S. Goldwasser. Incremental Cryptography and Application to Virus Protection. Proceedings of the 27th ACM Symposium on the Theory of Computing, May 1995
NPL 3: David McGrew, Efficient Authentication of large, dynamic data sets using Galois/Counter Mode (GCM), 3rd International IEEE Security in Storage Workshop, Dec. 13, 2005.
NPL 4: Marc Fischlin: Incremental Cryptography and Memory Checkers. EUROCRYPT 1997: 293-408
NPL 5: T. Iwata, K. Kurosawa, OMAC: One-Key CBC MAC, Fast Software Encryption, International Workshop, FSE 2003, Lecture Notes in Computer Science; Vol. 2887, February 2003
NPL 6: T. Iwata: New Blockcipher Modes of Operation with Beyond the Birthday Bound Security. FSE 2006: 310-327.
NPL 7: Cees J. A. Jansen, Stream Cipher Design based on Jumping Finite State Machines, Cryptology ePrint Archive: Report 2005/267

### SUMMARY OF INVENTION

### Technical Problem

However, in the example of the PMAC, a mask variable f_i stirs an input value M of E(K, *) before encryption of the input value M. Specifically, in the PMAC, processings other than the variation of the block, for example, insertion, deletion, and cut-and-paste of the block may be performed. In this case, the incremental processing is impossible in the PMAC. For example, after the tag of M=(M[1], M[2], . . . , M[L]) is calculated, when calculating a tag with respect to M′=(M[2], . . . , M[L]) from which a head block is deleted, input values of E(K, *) in M and M′ are

M: f_{—}1+M[1], f_{—}2+M[2], . . . , f_{—}L−1+M[L−1]

and

M′: f_{—}1+M[2], f_{—}2+M[3], . . . , f_{—}L−1+M[L−2],

respectively.

In the above example, values of blocks corresponding to M and M′ are different from each other if there is no special relationship such as M[1]=M[2]=M[3]. Therefore, there is a problem that the calculation result of the tag in M cannot be used to calculate the tag in M′. The same problem occurs even when an encryption result of each block inside a device of a message receiver is cached. The same problem occurs in the existing other incremental MACs such as the XORMAC described in NPL 2 and the GMAC described in NPL 3.

Furthermore, as in the IncXMACC described in NPL 4, there is a method of supporting various processings other than the variation of the block unit. However, in the normal tag calculation instead of the incremental tag calculation, the efficiency is worse than that of the general scheme, and the normal tag calculation cannot support the editing of all block units.

Furthermore, a method of dividing a message into blocks of n-bit units and carrying out padding on the blocks of the message when a certain block is less than n bits is disclosed in NPL 5. Moreover, a pseudo random function based on a block cipher is disclosed in NPL 6 as an example of an encryption function. In addition, a linear shift register is disclosed in NPL 7 as an example of processing used for a scrambling function to be described below.

As described above, as a general method of authenticating a message, only the method that has excellent efficiency but merely supports the variation of the block unit, and the method that can also support processings other than the variation of the block unit but has poor efficiency in the tag calculation are known.

The present invention provides an incremental MAC tag generation device, method, and program, and a message authentication device that enable incremental tag calculations that can support the editing of all block units, without losing the efficiency of normal tag calculation.

### Solution to Problem

An incremental MAC tag generation device according to the present invention includes: a padding means configured to input a final block of a plaintext (M) that has been divided into a plurality of blocks, and carry out padding on the final block of the plaintext (M) when a length of the final block of the plaintext (M) is less than a predetermined number of bits; a cache reference parallel encryption means configured to input blocks of the plaintext (M) other than the final block, a cached plaintext (M′), and an intermediate variable (S′) obtained by encrypting the plaintext (M′), and calculate an intermediate variable (S); a scrambled hash means configured to carry out scrambling processing on the intermediate variable (S), and calculate a hash value (V) by performing exclusive OR (XOR) on respective blocks of the scrambled intermediate variable (S) and the final block of the plaintext (M) output from the padding means; and a tag generation means configured to calculate a tag by encrypting the hash value (V) by using a parameter to indicate the presence or absence of the padding by the padding means, wherein the cache reference parallel encryption means compares the blocks of the plaintext (M) other than the final block with respective blocks of the plaintext (M′), when there exists a block of the plaintext (M′) matched with a block of the plaintext (M), the cache reference parallel encryption means uses a block of the intermediate variable (S′) corresponding to the block of the plaintext (M′) in the intermediate variable (S), and when there exists no block of the plaintext (M′) matched with a block of the plaintext (M), the cache reference parallel encryption means encrypts the block of the plaintext (M) and uses the encrypted block of the plaintext (M) in the intermediate variable (S).

An incremental MAC tag generation method according to the present invention includes: inputting a final block of a plaintext (M) that has been divided into a plurality of blocks, and carrying out padding on the final block of the plaintext (M) when a length of the final block of the plaintext (M) is less than a predetermined number of bits; inputting blocks of the plaintext (M) other than the final block, a cached plaintext (M′), and an intermediate variable (S′) obtained by encrypting the plaintext (M′); comparing the blocks of the plaintext (M) other than the final block with respective blocks of the plaintext (M′); when there exists a block of the plaintext (M′) matched with a block of the plaintext (M), using a block of the intermediate variable (S′) corresponding to the block of the plaintext (M′) in the intermediate variable (S); when there exists no block of the plaintext (M′) matched with a block of the plaintext (M), calculating the intermediate variable (S) by encrypting the block of the plaintext (M); performing scrambling processing on the intermediate variable (S), and calculating a hash value (V) by performing exclusive OR (XOR) on respective blocks of the scrambled intermediate variable (S) and the final block of the plaintext (M); and calculating a tag by encrypting the hash value (V) by using a parameter to indicate the presence or absence of padding.

An incremental MAC tag generation program according to the present invention causes a computer to execute: inputting a final block of a plaintext (M) that has been divided into a plurality of blocks, and carrying out padding on the final block of the plaintext (M) when a length of the final block of the plaintext (M) is less than a predetermined number of bits; inputting blocks of the plaintext (M) other than the final block, a cached plaintext (M′), and an intermediate variable obtained by encrypting the cached plaintext (S′); comparing the blocks of the plaintext (M) other than the final block with respective blocks of the plaintext (M′); when there exists a block of the plaintext (M′) matched with a block of the plaintext (M), using a block of the intermediate variable (S′) corresponding to the block of the plaintext (M′) in the intermediate variable (S); when there exists no block of the plaintext (M′) matched with a block of the plaintext (M), calculating the intermediate variable (S) by encrypting the block of the plaintext (M); performing scrambling processing on the intermediate variable (S), and calculating a hash value (V) by performing exclusive OR (XOR) on respective blocks of the scrambled intermediate variable (S) and the final block of the plaintext (M); and calculating a tag by encrypting the hash value (V) by using a parameter to indicate the presence or absence of padding.

### Advantageous Effects of Invention

According to the present invention, it is possible to enable the incremental tag calculation that can support the editing of all block units, without losing the efficiency of normal tag calculations.

### BRIEF DESCRIPTION OF DRAWINGS

FIG. 1 It depicts a block diagram illustrating a configuration of an incremental MAC tag generation device according to a first exemplary embodiment of the present invention.

FIG. 2 It depicts a block diagram illustrating processing of the incremental MAC tag generation device according to the first exemplary embodiment of the present invention.

FIG. 3 It depicts a block diagram illustrating data flow in the incremental MAC tag generation device according to the first exemplary embodiment of the present invention.

FIG. 4 It depicts a flowchart illustrating an operation of the incremental MAC tag generation device according to the first exemplary embodiment of the present invention.

FIG. 5 It depicts a block diagram illustrating a configuration of a message authentication device according to a second exemplary embodiment of the present invention.

FIG. 6 It depicts a flowchart illustrating an operation of the message authentication device according to the second exemplary embodiment of the present invention.

FIG. 7 It depicts a block diagram illustrating main parts of the incremental MAC tag generation device according to the present invention.

FIG. 8 It depicts a block diagram illustrating an operation of a general tag generation device using a PMAC.

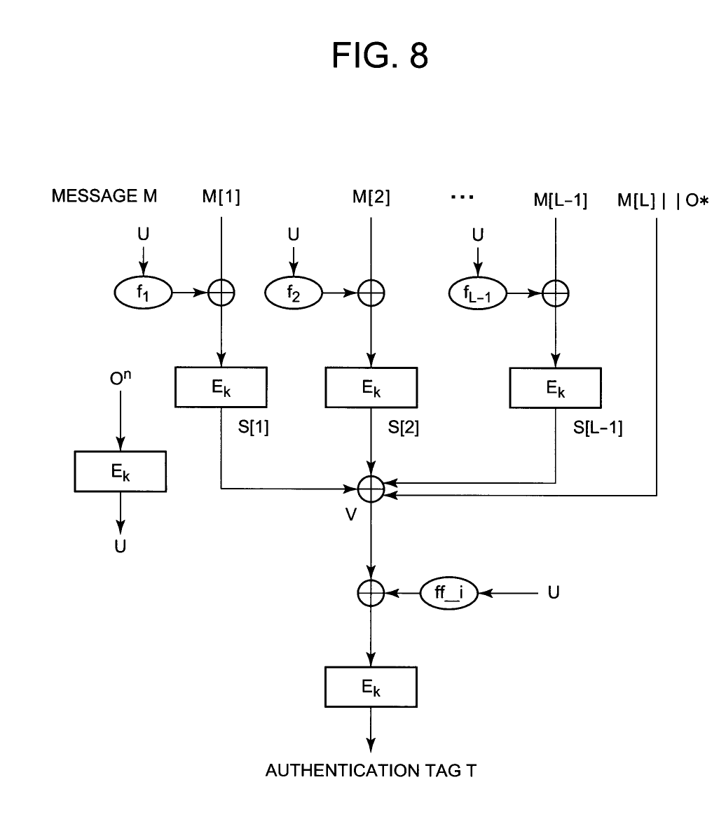

### DESCRIPTION OF EMBODIMENTS

Hereinafter, exemplary embodiments of the present invention will be described in detail with reference to the accompanying drawings.

### First Exemplary Embodiment

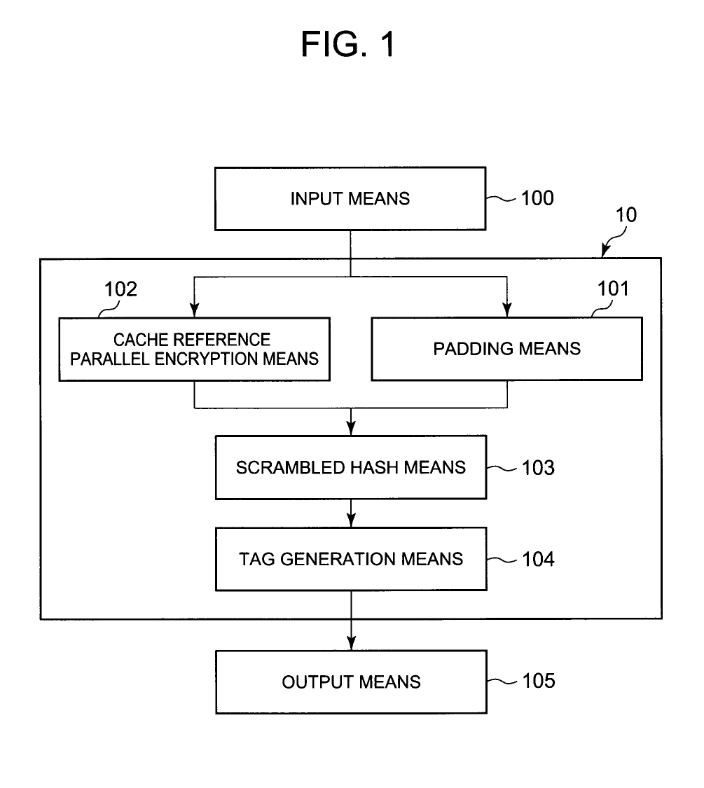

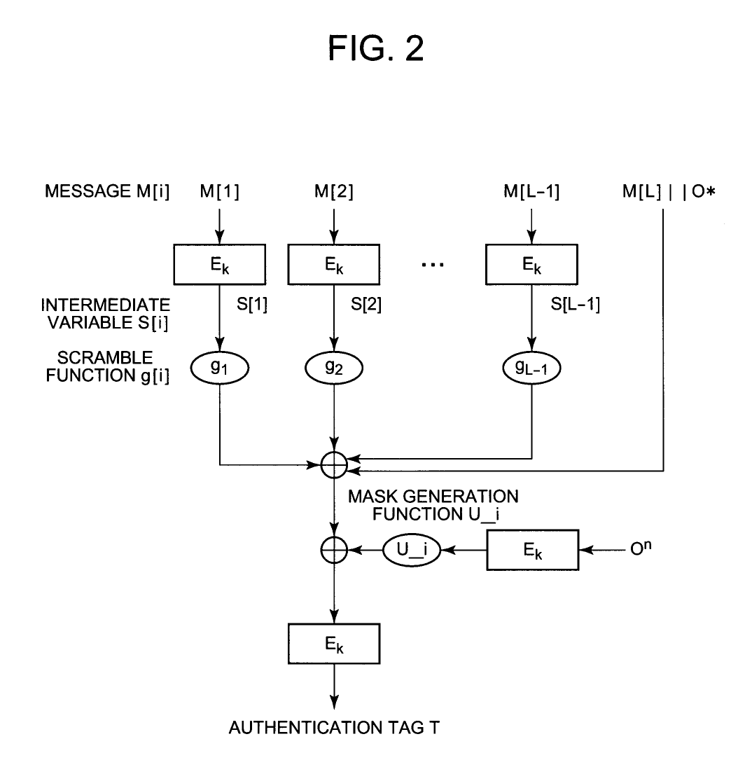

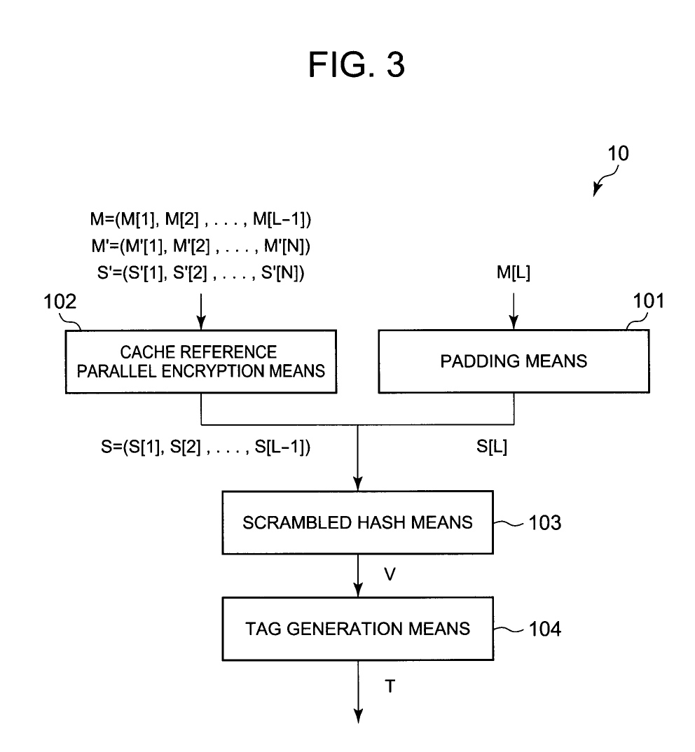

FIG. 1 is a block diagram illustrating a configuration of an incremental MAC tag generation device according to a first exemplary embodiment of the present invention. FIG. 2 is a block diagram illustrating processing of the incremental MAC tag generation device according to the first exemplary embodiment of the present invention. FIG. 3 is a block diagram illustrating data flow in the incremental MAC tag generation device according to the first exemplary embodiment of the present invention. Furthermore, in the following description, unless expressly specified otherwise, + represents a bit-by-bit XOR and a length of one block of a message is n bits.

An incremental MAC tag generation device 10 according to the exemplary embodiment includes a padding means 101, a cache reference parallel encryption means 102, a scrambled hash means 103, and a tag generation means 104. Furthermore, an input means 100 and an output means 105 are connected to the incremental MAC tag generation device 10. For example, the incremental MAC tag generation device 10 is realized by a central processing unit (CPU), a memory, and a disc. For example, each means of the incremental MAC tag generation device 10 is implemented to operate a program on a CPU, the program being stored in a disc of a computer.

The input means 100 inputs a plaintext M=(M[1], . . . , M[L]) to be authenticated, a cached plaintext M′=(M′[1], . . . , M′[N]), and a cached intermediate variable S′=(S′[1], . . . , S′[N]). The plaintext M and the cached plaintext M′ are divided by n-bit block unit. For example, the input means 100 is realized by a character input device such as a keyboard. Furthermore, the input means 100 may include, for example, a communication interface such as a local area network (LAN) or a universal serial bus (USB) of a computer, or an input interface on a program.

The padding means 101 inputs a final block M[L] of the plaintext M from the input means 100. When a block length of the final block M[L] is less than n bits, the padding means 101 carries out padding on the plaintext M up to n bits. Specifically, when pad is a padding function and M[L] is a final block of a message, the padding means 101 outputs S[L]=pad(M[L]) as a final block of an intermediate variable. A padding type of the padding means 101 is optional. For example, all zeros may be connected. In this regard, when the final block is just n bits, no processing is carried out. Specifically, when M[L] is n bits, S[L]=M[L]. When M[L] is less than n bits, for example, S[L]=M[L]∥0*(∥0* represents zero padding). This is a standard padding type used in the OMAC or the like described in NPL 5.

The cache reference parallel encryption means 102 encrypts only a block requiring an input plaintext M by block unit in parallel with reference to a cache. Specifically, first, the plaintext M=(M[1], . . . , M[L−1]), the cached plaintext M′, and the cached intermediate variable S′=(S′[1], . . . , S′[N]) are input from the input means 100.

When K is a secret key and E(K, *) is an encryption function, the cache reference parallel encryption means 102 calculates the intermediate variable S[i] as expressed in the following Equation Scomp by using the cached plaintext M′=(M′[1], . . . , M′[N]) (in this regard, M′[1], . . . , M′[N] are all n bits) and the cached intermediate variable S′=(S′[1], . . . , S′[N]) (in this regard, S′[i]=E(K, M′[i]), for all i=1, . . . , N) in each of the blocks M[1], . . . , M[L−1] of M.

S[i]=S′[j] if M[i]=M′[j] for some j,S[i]=E(K,M[i]) otherwise (Equation Scomp)

The cache reference parallel encryption means 102 carries out the processing with respect to i=1, . . . , L−1, and outputs the intermediate variable S=(S[1], . . . , S[L−1]). In this case, both the intermediate variable S[i] and the plaintext M[i] are n bits, and encryption of an n-bit block cipher is considered as the processing of the E. This processing corresponds to an Electric Code Book (ECB) mode with respect to M[1], . . . , M[L−1].

As such, when the cache reference parallel encryption means 102 finds a block matched with the block of the sent plaintext M[i] among all blocks of the cached plaintext M′[j], the cache reference parallel encryption means 102 uses S′[j] corresponding to M′[j]. Therefore, even when processings other than the variation of the block unit, for example, insertion, deletion, and cut-and-paste of the block are performed on M[i], the incremental tag calculation can be carried out.

Alternatively, a plurality of blocks, for example, c blocks of the plaintext M may be grouped to obtain S[i]=E(K, (M[c×(i−1)+1], M[(c×(i−1)+2], . . . , M[(c×(i−1)+c]) (in this case, + represents the sum). The cache reference parallel encryption means 102 carries out the processing with respect to i=1, . . . , L/c−1, and outputs the intermediate variable S=(S[1], . . . , S[L/c−1]). Both of S[i] and M[i] are n bits, but the input length of E is greater than the output length. In this case, as the processing of the block cipher E, a CBC-MAC or a CMAC may be considered according to the n-bit block cipher or the like.

Furthermore, the input of the block cipher E is M[i] of n bits, but the length of the intermediate variable S[i] being the output may be greater than n bits. In this case, a key stream generation function with an initialization vector (IV) may be used as the processing of the block cipher E, the plaintext M[i] instead of the IV may be used as the input, and the intermediate variable S[i] may be used as the output. Alternatively, the pseudo random function based on the block cipher such as the CENC as described in NPL 6 may be used. In each case, if there is no cached plaintext and intermediate variable, all plaintext blocks have only to be encrypted.

The scrambled hash means 103 scrambles the intermediate variable S output from the cache reference parallel encryption means 102 at each block to obtain a hash value V. Specifically, when S=(S[1], . . . , S[L−1]), the scrambled hash means 103 calculates the hash value V expressed as the following Equation by using a scramble function g_i for i=1, . . . , L−1 to output the hash value V.

V=g_{—}1(S[1])+g_{—}2(S[2])+ . . . +g_{—}L−1(S[L−1])+S[L] (Equation scrm)

Herein, S[L] is output from the padding means 101 and is a value on which the padding is carried out to a final block M[L] of a message when necessary.

Hereinafter, a scramble function g_i will be descried in detail with reference to a specific example. The scramble function g_i for i=1, . . . , L−1, u_{—}0, and u_{—}1 are determined to satisfy conditions represented in the following Equation scrcond in order to ensure stability.

Pr[sum_{—}{i in Gset}g_{—}i(rand)+sum_{—}{j in Uset}u_{—}j(rand)=y] (Equation scrcond)

Pr[X=x] represents a probability that a probability variable X will take a value x. The scramble function g_i is accomplished if all n-bit values y capable of being obtained with respect to all subsets Gset of {1, . . . , L−1} excluding the zero group and all subsets of {0, 1} including the zero group (that is, {0}, {1}, {0, 1}) Uset may be sufficiently small when the rand of the above Equation is set to an n-bit uniform random number.

In order to satisfy the conditions as represented in the Equation scrcond, for example, g_i and u_j are configured using a cyclic shift of a partial sequence having a prime length of n bits. For example, X is set to have n bits, X[a−b] is set as a partial sequence from an a-th bit to a b-th bit, and rot(i, Y) is set as an i-bit left (or right) cyclic shift of Y. In this case, g_i(X), u_{—}0(X), and u_{—}1(X) may be determined as expressed in the following Equation (+ in the following Equation rot represents the sum).

g_{—}i(X)=rot(i, X[1−p])∥X[p+1−n], for i=1, . . . , Lmax−1

u_{—}0(X)=rot(Lmax,X[1−p])∥X[p+1−n]

u_{—}1(X)=rot(Lmax+1,X[1−p])∥X[p+1−n] (Equation rot)

g_i is determined as described above and can support up to a maximum block length Lmax of a message. However, p is a prime number and needs to satisfy the relationship of p≦Lmax+1≦n. As compared with a block cipher that repeats complex calculations a plurality of times, the processing is completed by only the cyclic shift processing. Hence, the processing can be performed at a high speed. Furthermore, X[p+1−n] in the Equation rot may also be a predetermined fixed sequence such as all zeros. Furthermore, when cp≦n with respect to a positive integer being a divisor of n, X is divided by c, and the same processing as in Equation rot with may be independently applied to a partial sequence of each n/c bit.

In addition, for example, g_i and u_j may be implemented by a multiplication of constants in a finite field GF(2̂n). If an appropriate constant a_i is determined and a set {a_{—}1, . . . , a_Lmax+1} configures a base on the finite field GF(2̂n) (linear independence), g_i(X), u_{—}0(X), and u_{—}1(X) may be determined as expressed in the following Equation (+ in the following Equation mul represents the sum).

g_{—}i(X)=mul(a_{—}i, X) for i=1, . . . , Lmax−1

u_{—}0(X)=mul(a_{—}Lmax,X)

u_{—}1(X)=mul(a_{—}Lmax+1,X) (Equation mul)

In the Equation mul, the mul(A, B) represents a multiplication of elements A and B in the finite field. g_i can support up to a maximum block length Lmax of the message by determining g_i in this manner.

Moreover, for example, g_i and u_j may be implemented by a linear shift register (LFSR) as expressed in the following Equation (+ in the following Equation LFSR represents the sum).

g_{—}i(X)=LFSR(i, X) for i=1, . . . , Lmax−1

u_{—}0(X)=LFSR(Lmax,X)

u_{—}1(X)=LFSR(Lmax+1,X) (Equation LFSR)

g_i can support up to a maximum block length Lmax of a message by determining g_i in this manner.

Herein, when a register of the linear shift register is set as X, LFSR (i, X) is a content of the register after i operations. In general, the calculation of g_i requires i LFSR operations. However, as described in NPL 7, in a type of LFSR, called Jump LFSR, a plurality of operations may be processed in the same manner as almost one operation. Thus, the use of such LFSR can improve the efficiency.

As described above, g_i is implemented by a cyclic shift represented in the Equation rot, a multiplication of constants in the finite field GF (2̂n) represented in the Equation mul, or a linear shift register represented in the Equation LFSR. Therefore, g_i is determined to satisfy the condition represented in the Equation scrcond so that the stability is ensured.

The tag generation means 104 generates a tag T by encrypting the hash value V output from the scrambled hash means 103 by using a binary parameter to indicate whether the length of the final block M[L] in the plaintext M is n bits.

Specifically, when the hash value V is n bits, the tag T is determined as expressed in the following Equation by using the encryption function E(K, *) of the block cipher.

T=E(K,u_{—}0(U)+V) if |M[L]|=n,T=E(K,u_{—}1(U)+V) otherwise (Equation fin)

Then, the tag generation means 104 outputs T obtained from the Equation fin as the tag. Herein, U=E(K, 0̂n). For example, functions u_{—}0 and u_{—}1 which generate a mask are realized by a cyclic shift represented in the above Equation rot, a multiplication of constants in a finite field GF (2̂n) represented in the above Equation mul, or a linear shift register represented in the above Equation LFSR.

Furthermore, the tag T may be simply determined by simply preparing two keys as expressed in the following Equation.

T=E(K1,V) if |M[L]|=n,T=E(K2,V) otherwise (Equation fin2)

Even if either of the Equation fin and the Equation fin2 is used, the tag generation means 104 performs encryption by using a binary parameter to indicate whether the length of the final block M[L] of the plaintext M is n bits. Therefore, efficient processing may be realized while eliminating ambiguity caused by padding (whether the intermediate variable S[L] is the final block M[L] or is obtained by padding the final block M[L], is not known from the intermediate variable S[L] alone).

The processings represented in the Equation fin and the Equation fin2 are the standard technique used in the OMAC described in NPL 5 in the same manner as the function of the padding means 101. In addition, when the hash value V is longer than a block size of a block cipher to be used, a mode such as a CBC-MAC or a CMAC may be used.

The tag T generated by the tag generation means 104 is output to the output means 105. The output means 105 outputs the tag T generated from the tag generation means 104 to, for example, a computer display, a printer, or the like.

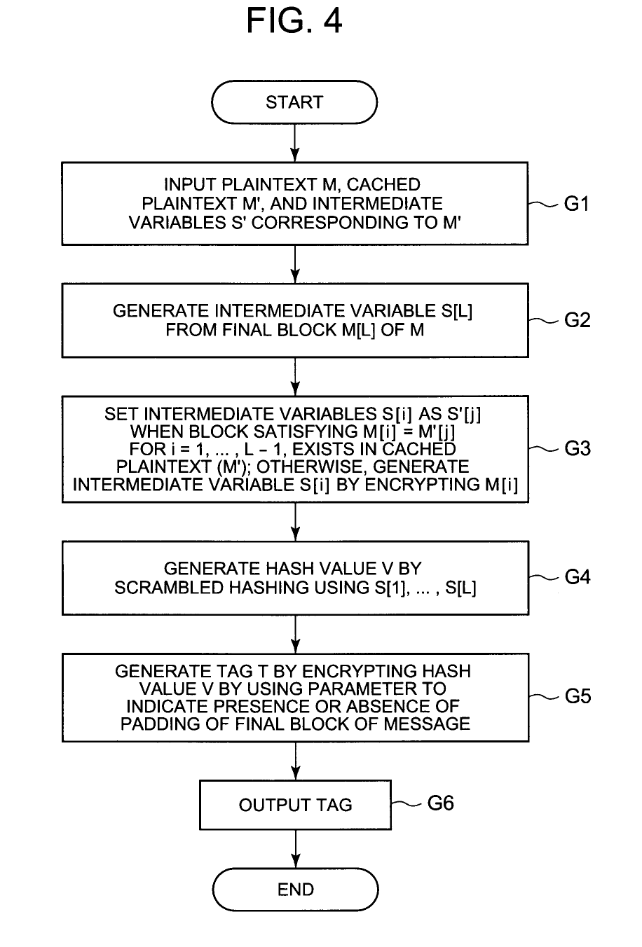

Hereinafter, the operation of the incremental MAC tag generation device according to the first exemplary embodiment of the present invention will be described. FIG. 4 is a flowchart illustrating the operation of the incremental MAC tag generation device according to the first exemplary embodiment of the present invention.

First, the incremental MAC tag generation device 10 inputs a plaintext M=(M[1], M[2], . . . , M[L]) to be authenticated, a cached plaintext M′=(M′[1], . . . , M′[N]), and a cached intermediate variable S′=(S′[1], . . . , S′[N−1]) corresponding to the plaintext M′ from the input means 100 (step G1).

Next, when a final block M[L] of a message is less than n bits, the padding means 101 carries out padding on the final block M[L] of the message to set the padding result as the intermediate variable S[L]. When the final block M[L] is just n bits, the padding means 101 sets the final block M[L] as the intermediate variable S[L] as it is (step G2).

After that, the cache reference parallel encryption means 102 obtains an intermediate variable S[i] from the block M[i] of the plaintext with respect to i=1, . . . , L−1. In this regard, when j satisfying M[i]=M′[j] exits, the cache reference parallel encryption means 102 sets a copy of S′[j] as S[j]. When such j does not exist, the cache reference parallel encryption means 102 obtains S[i] by encrypting M[i] (step G3).

Next, the scrambled hash means 103 applies the intermediate variable S[i] to the scramble function g_i. Then, the scrambled hash means 103 generates and outputs a hash value V which is the sum of S[L] and the result of XOR performed on g_i (S[i]) with respect to i=1, . . . , L−1 (step G4).

Then, the tag generation means 104 generates a tag T by encrypting the hash value V by using a binary parameter to indicate whether the padding is performed on the final block M[L] of the plaintext (that is, whether M[L] is n bits) (step G5). Finally, the output means 105 outputs the tag T (step G6).

The incremental MAC tag generation device 10 of the exemplary embodiment can recalculate the incremental tag with respect to processing of all block units and can efficiently perform normal tag calculations. This is because the result obtained by encrypting the block M[i] of each message transparently acts with respect to the editing of all block units. Thus, calculation of new encryption is not required.

Furthermore, since the processing of each M[i] can be performed in parallel and the scrambling processing is realized by remarkably simple processing as compared with the block cipher, the speed is remarkably increased as a whole. When there is no cached plaintext, the intermediate variable S may be obtained by encrypting all M[i].

In addition, regarding the updating of block unit without insertion, deletion, and cut-and-paste of the block, when decoding processing exists in encryption of the hash value as in the processing of the present exemplary embodiment and processing of each g_i is further substituted (that is, an inverse function exists), the incremental tag can be calculated from the message and the tag even when the intermediate variable is not cached, as in the same manner as the PMAC described in NPL 1.

### Second Exemplary Embodiment

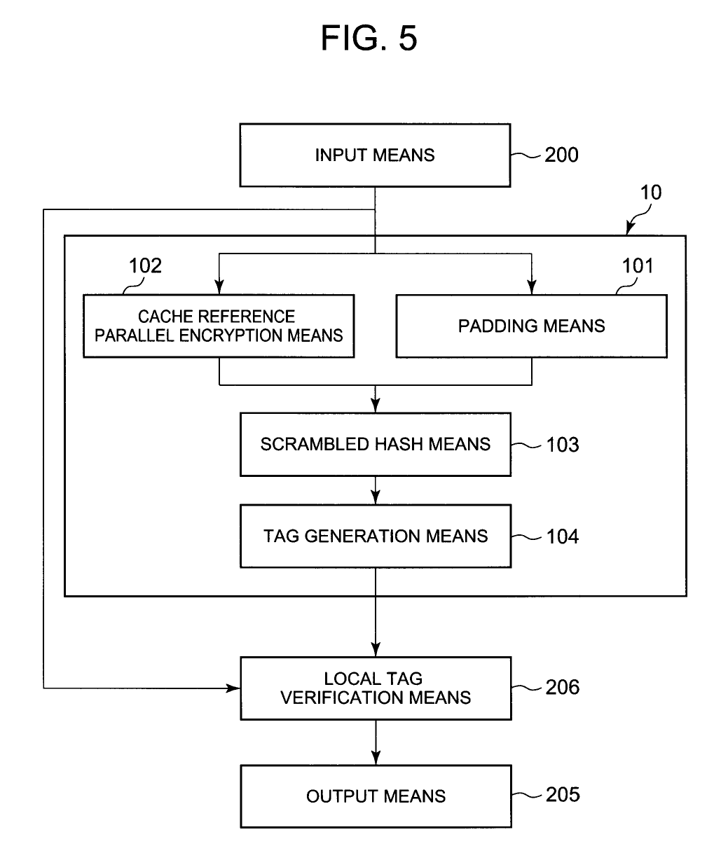

FIG. 5 is a block diagram illustrating a configuration of a message authentication device according to a second exemplary embodiment of the present invention. As illustrated in FIG. 5, the message authentication device according to the second exemplary embodiment includes an input means 200, an incremental MAC tag generation device 10, a local tag verification means 206, and an output means 205. The configuration and operation of the incremental MAC tag generation device 10 are the same as those described in the first exemplary embodiment.

The input means 200 is connected to the incremental MAC tag generation device 10 and the local tag verification means 206. The input means 200 inputs a plaintext M to be authenticated, a tag T corresponding to the plaintext M, a cached plaintext M′, and a cached intermediate variable S′. The input means 200 is realized by a character input device such as a keyboard. Furthermore, the input means 200 may include, for example, a communication interface such as an LAN or a USB of a computer, or an input interface on a program.

The incremental MAC tag generation device 10 is connected to the local tag verification means 206 and has a function of generating the tag as described in the first exemplary embodiment. In the present exemplary embodiment, the tag generated by the incremental MAC tag generation device 10 is referred to as a local tag Z.

The local tag verification means 206 verifies the local tag Z input from the incremental MAC tag generation device 10 by comparing the tag T input from the input means 200 with the input local tag Z. In addition, the local tag verification means 206 is connected to the output means 205. The local tag verification means 206 transmits the verification result to the output means 205. The output means 205 outputs the verification result output from the local tag verification means 206 to, for example, a computer display, a printer, or the like.

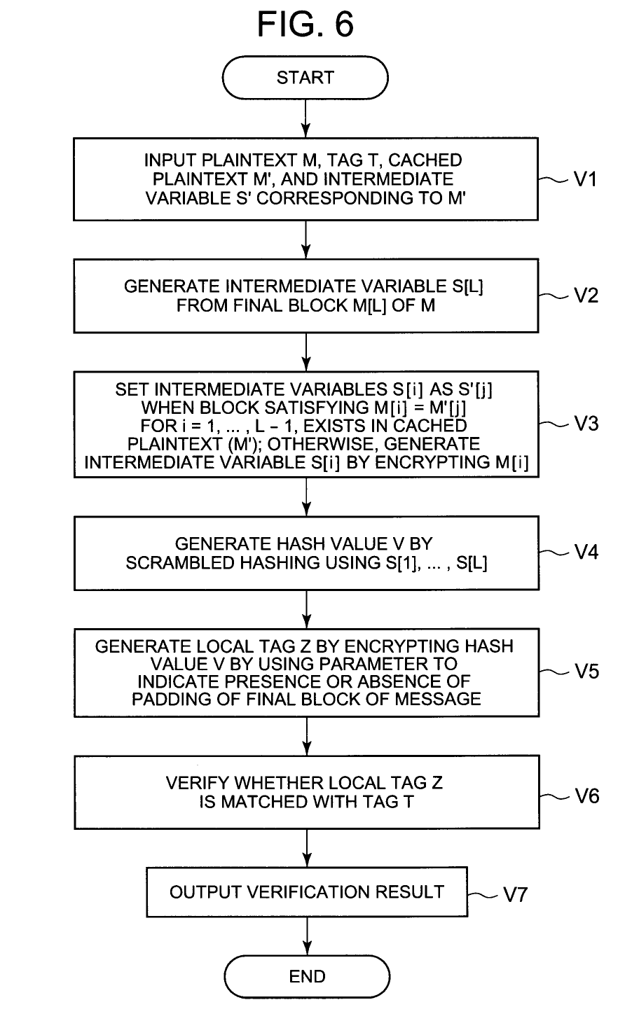

FIG. 6 is a flowchart illustrating the operation of the message authentication device according to the second exemplary embodiment of the present invention. First, a plaintext M=(M[1], M[2], . . . , M[L]) to be authenticated, a tag T corresponding to the plaintext M, a cached plaintext M′=(M′[1], . . . , M′[N]), and a cached intermediate variable S′=(S′[1], . . . , S′[N−1]) corresponding to the cached plaintext M′ are input by the input means 200 (step V1).

Then, when a final block M[L] of a message is less than n bits, the padding means 101 carries out padding on the final block M[L] of the message to set the padding result as the intermediate variable S[L]. When the final block M[L] is just n bits, the padding means 101 sets the final block M[L] as the intermediate variable S[L] as it is (step V2).

After that, the cache reference parallel encryption means 102 obtains an intermediate variable S[i] from the block M[i] of the plaintext with respect to i=1, . . . , L−1. When j satisfying M[i]=M′[j] exists, the cache reference parallel encryption means 102 sets a copy of S′[j] as S[i]. When such j does not exist, the cache reference parallel encryption means 102 obtains S[i] by encrypting M[i] (step V3).

Then, the scrambled hash means 103 applies the intermediate variable S[i] to the scramble function g_i. Then, the scrambled hash means 103 generates a hash value V by performing XOR on g_i (S[i]) with respect to i=1, . . . , L−1 and performing XOR on the XOR result and S[L] (step V4).

Then, the tag generation means 104 generates a local tag Z by encrypting the hash value V by using a binary parameter to indicate whether the padding is performed on the final block M[L] of the plaintext (that is, whether M[L] is n bits) (step V5).

Then, the local tag verification means 206 verifies whether the local tag Z input from the tag generation means 104 is matched with the tag T input from the input means 200 (step V5). Finally, the output means 205 outputs the verification result of the local tag verification means 206 (step V6).

The message authentication device of the second exemplary embodiment obtains the same effects as those of the first exemplary embodiment. Therefore, the message can be efficiently authenticated.

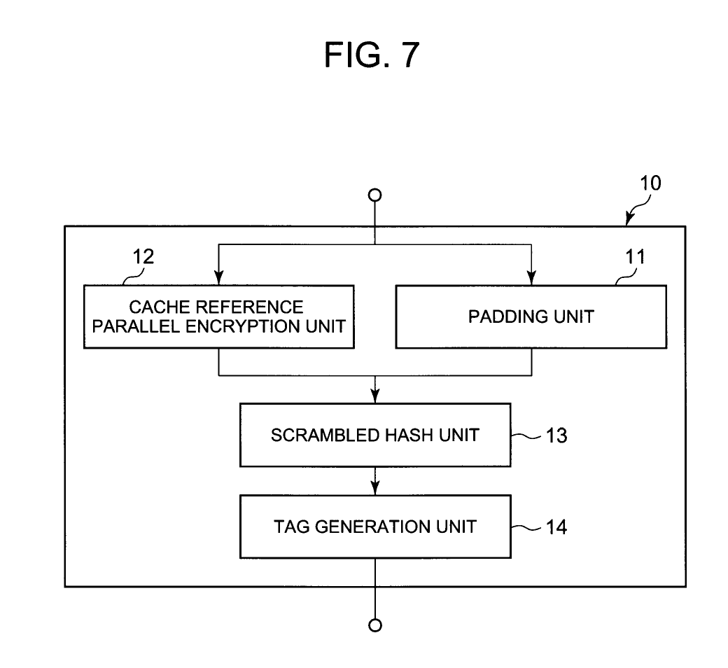

FIG. 7 is a block diagram illustrating main parts of the incremental MAC tag generation device according to the present invention. As illustrated in FIG. 7, the incremental MAC tag generation device 10 includes a cache reference parallel encryption unit 12, a padding unit 11, a scrambled hash unit 13, and a tag generation unit 14 as minimum elements.

As illustrated in FIG. 7, in the incremental MAC tag generation device, the padding unit 11 inputs a final block of a plaintext M that has been divided into a plurality of blocks. When a length of the final block of the plaintext M is less than a predetermined number of bits, the padding unit 11 carries out padding on the final block of the plaintext M. The cache reference parallel encryption unit 12 inputs blocks of the plaintext M other than the final block, a cached plaintext M′, and an intermediate variable S′ obtained by encrypting the plaintext (M′), and calculates an intermediate variable S. The scrambled hash unit 13 carries out scrambling processing on blocks of the intermediate variable S other than the final block. The scrambled hash unit 13 calculates a hash value V by performing XOR on the scrambled blocks of the intermediate variable S and the final block of the plaintext M padded by the padding unit 11. The tag generation unit 14 calculates the tag T by encrypting the hash value V by using a parameter to indicate the presence or absence of the padding by the padding unit 11.

The cache reference parallel encryption unit 12 compares blocks of the plaintext M other than the final block with blocks of the plaintext M′, respectively. When there exists a block of a plaintext M′ matched with the block of the plaintext M, the cache reference parallel encryption unit 12 uses a block of an intermediate variable S′ corresponding to the block of the plaintext M′ in the intermediate variable S. When there exists no block of the plaintext M′ matched with the block of the plaintext M, the cache reference parallel encryption unit 12 encrypts the block of the plaintext M and uses the encrypted block of the plaintext M in the intermediate variable S.

Therefore, the incremental MAC tag generation device illustrated in FIG. 7 can calculate the incremental tag that can support the editing of all block units, without losing the efficiency of normal tag calculations.

In addition, in the respective exemplary embodiments, incremental MAC tag generation devices and message authentication devices are also disclosed as described in the following (1) to (5).

(1) An incremental MAC tag generation device (for example, incremental MAC tag generation device 10) includes: a padding means (for example, padding means 101) configured to input a final block of a plaintext M that has been divided into a plurality of blocks, and carry out padding on the final block of the plaintext M when a length of the final block of the plaintext M is less than a predetermined number of bits; a cache reference parallel encryption means (for example, cache reference parallel encryption means 102) configured to input blocks of the plaintext M other than the final block, a cached plaintext M′, and an intermediate variable S′ obtained by encrypting the plaintext M′, and calculate an intermediate variable S; a scrambled hash means (for example, scrambled hash means 103) configured to carry out scrambling processing on the intermediate variable S, and calculate a hash value V by performing exclusive OR (XOR) on respective blocks of the scrambled intermediate variable S and the padded final block of the plaintext M output from the padding means; and a tag generation means (for example, tag generation means 104) configured to calculate a tag by encrypting the hash value V by using a parameter to indicate the presence or absence of the padding by the padding means, wherein the cache reference parallel encryption means compares the blocks of the plaintext M other than the final block with respective blocks of the plaintext M′, when there exists a block of the plaintext M′ matched with a block of the plaintext M, the cache reference parallel encryption means uses a block of the intermediate variable S′ corresponding to the block of the cached plaintext M′ in the intermediate variable S, and when there exists no block of the plaintext M′ matched with a block of the plaintext M, the cache reference parallel encryption means encrypts the block of the plaintext M and uses the encrypted block of the plaintext M in the intermediate variable S.

(2) In the incremental MAC tag generation device, the scrambling processing of the scrambled hash means cyclically shifts a partial sequence having a specific prime length of each of the blocks of the input intermediate variable S.

(3) In the incremental MAC tag generation device, the scrambling processing of the scrambled hash means multiplies the respective input blocks of the intermediate variable S by constants having different values in a specific finite field.

(4) In the incremental MAC tag generation device, the scrambling processing of the scrambled hash means applies respective input blocks of the intermediate variable S to a linear shift register, and performs operations as many as the same number as the input blocks.

(5) A message authentication device includes: an incremental MAC tag generation device (for example, incremental MAC tag generation device 10); an input means (for example, input means 200) configured to input a plaintext M, a tag T corresponding to the plaintext M, a cached plaintext M′, and an intermediate variable S′ obtained by encrypting the plaintext M′; a local tag verification means (for example, local tag verification means 206) configured to verify a local tag Z generated by the incremental MAC tag generation device by comparing the local tag Z with the tag T input from the input means by using the plaintext M, the plaintext M′, and the intermediate variable S′; and an output means (for example, output means 205) configured to output the verification result of the local tag verification means.

This application is based upon and claims the benefit of priority from Japanese Patent Application No. 2011-239232, filed Oct. 31, 2011, the entire contents of which are incorporated herein by reference.

The present invention has been described above with reference the exemplary embodiments, but the present invention is not limited to the above exemplary embodiments. Various modifications can be made by those skilled in the art, without departing from the scope of the present invention to the configuration and details of the present invention.

### INDUSTRIAL APPLICABILITY

According to the present invention, the present invention can be applied to applications such as authentication of wireless or wired data communications, tampering detection of database, legitimacy verification of memory in devices.

### REFERENCE SIGNS LIST

10 Incremental MAC tag generation device
11 Padding unit
12 Cache reference parallel encryption unit
13 Scrambled hash unit
14 Tag generation unit
100 Input means
101 Padding means
102 Cache reference parallel encryption means
103 Scrambled hash means
104 Tag generation means
105 Output means
200 Input means
205 Output means
206 Local tag verification means

1. An incremental MAC tag generation device comprising:
a padding unit configured to input a final block of a plaintext (M) that has been divided into a plurality of blocks, and carry out padding on the final block of the plaintext (M) when a length of the final block of the plaintext (M) is less than a predetermined number of bits;
a cache reference parallel encryption unit configured to input blocks of the plaintext (M) other than the final block, a cached plaintext (M′), and an intermediate variable (S′) obtained by encrypting the plaintext (M′), and calculate an intermediate variable (S);
a scrambled hash unit configured to carry out scrambling processing on the intermediate variable (S), and calculate a hash value (V) by performing exclusive OR (XOR) on respective blocks of the scrambled intermediate variable (S) and the final block of the plaintext (M) output from the padding unit; and
a tag generation unit configured to calculate a tag by encrypting the hash value (V) by using a parameter to indicate the presence or absence of the padding by the padding unit,
wherein the cache reference parallel encryption unit compares the blocks of the plaintext (M) other than the final block with respective blocks of the plaintext (M′),
when there exists a block of the plaintext (M′) matched with a block of the plaintext (M), the cache reference parallel encryption unit uses a block of the intermediate variable (S′) corresponding to the block of the plaintext (M′) in the intermediate variable (S), and
when there exists no block of the plaintext (M′) matched with a block of the plaintext (M), the cache reference parallel encryption unit encrypts the block of the plaintext (M) and uses the encrypted block of the plaintext (M) in the intermediate variable (S).

2. The incremental MAC tag generation device according to claim 1, wherein the scrambling processing of the scrambled hash unit cyclically shifts a partial sequence having a specific prime length of each of the blocks of the input intermediate variable (S).

3. The incremental MAC tag generation device according to claim 1, wherein the scrambling processing of the scrambled hash unit multiplies the respective input blocks of the intermediate variable (S) by constants having different values in a specific finite field.

4. The incremental MAC tag generation device according to claim 1, wherein the scrambling processing of the scrambled hash unit applies respective input blocks of the intermediate variable (S) to a linear shift register, and performs operations as many as the same number as the input blocks.

5. A message authentication device comprising:
an incremental MAC tag generation device according to claim 1;
an input unit configured to input a plaintext (M), a tag (T) corresponding to the plaintext (M), a cached plaintext (M′), and an intermediate variable (S′) obtained by encrypting the plaintext (M′);
a local tag verification unit configured to verify a local tag (Z) generated by the incremental MAC tag generation device by comparing the local tag (Z) with the tag (T) input from the input unit by using the plaintext (M), the plaintext (M′), and the intermediate variable (S′); and
an output unit configured to output the verification result of the local tag verification unit.

6. An incremental MAC tag generation method comprising:
inputting a final block of a plaintext (M) that has been divided into a plurality of blocks, and carrying out padding on the final block of the plaintext (M) when a length of the final block of the plaintext (M) is less than a predetermined number of bits;
inputting blocks of the plaintext (M) other than the final block, a cached plaintext (M′), and an intermediate variable (S) obtained by encrypting the plaintext (M′);
comparing the blocks of the plaintext (M) other than the final block with respective blocks of the plaintext (M′);
when there exists a block of the plaintext (M′) matched with a block of the plaintext (M), using a block of the intermediate variable (S′) corresponding to the block of the plaintext (M′) in the intermediate variable (S);
when there exists no block of the plaintext (M′) matched with a block of the plaintext (M), calculating the intermediate variable (S) by encrypting the block of the plaintext (M);
performing scrambling processing on the intermediate variable (S), and calculating a hash value (V) by performing exclusive OR (XOR) on respective blocks of the scrambled intermediate variable (S) and the final block of the plaintext (M); and
calculating a tag by encrypting the hash value (V) by using a parameter to indicate the presence or absence of padding.

7. A non-transitory computer readable information recording medium storing an incremental MAC tag generation program that, when executed by a processor, performs a method for:
inputting a final block of a plaintext (M) that has been divided into a plurality of blocks, and carrying out padding on the final block of the plaintext (M) when a length of the final block of the plaintext (M) is less than a predetermined number of bits;
inputting blocks of the plaintext (M) other than the final block, a cached plaintext (M′), and an intermediate variable (S′) obtained by encrypting the plaintext (M′);
comparing the blocks of the plaintext (M) other than the final block with respective blocks of the plaintext (M′);
when there exists a block of the cached plaintext (M′) matched with a block of the plaintext (M), using a block of the intermediate variable (S′) corresponding to the block of the cached plaintext (M) in the intermediate variable (S);
when there exists no block of the plaintext (M′) matched with a block of the plaintext (M), calculating the intermediate variable (S) by encrypting the block of the plaintext (M);
performing scrambling processing on the intermediate variable (S), and calculating a hash value (V) by performing exclusive OR (XOR) on respective blocks of the scrambled intermediate variable (S) and the final block of the plaintext (M); and
calculating a tag by encrypting the hash value (V) by using a parameter to indicate the presence or absence of padding.

8. A message authentication device comprising:
an incremental MAC tag generation device according to claim 2;
an input unit configured to input a plaintext (M), a tag (T) corresponding to the plaintext (M), a cached plaintext (M′), and an intermediate variable (S′) obtained by encrypting the plaintext (M′);
a local tag verification unit configured to verify a local tag (Z) generated by the incremental MAC tag generation device by comparing the local tag (Z) with the tag (T) input from the input unit by using the plaintext (M), the plaintext (M′), and the intermediate variable (S′); and
an output unit configured to output the verification result of the local tag verification unit.

9. A message authentication device comprising:
an incremental MAC tag generation device according to claim 3;
an input unit configured to input a plaintext (M), a tag (T) corresponding to the plaintext (M), a cached plaintext (M′), and an intermediate variable (S′) obtained by encrypting the plaintext (M′);
a local tag verification unit configured to verify a local tag (Z) generated by the incremental MAC tag generation device by comparing the local tag (Z) with the tag (T) input from the input unit by using the plaintext (M), the plaintext (M′), and the intermediate variable (S′); and
an output unit configured to output the verification result of the local tag verification unit.

10. A message authentication device comprising:
an incremental MAC tag generation device according to claim 4;
an input unit configured to input a plaintext (M), a tag (T) corresponding to the plaintext (M), a cached plaintext (M′), and an intermediate variable (S′) obtained by encrypting the plaintext (M′);
a local tag verification unit configured to verify a local tag (Z) generated by the incremental MAC tag generation device by comparing the local tag (Z) with the tag (T) input from the input unit by using the plaintext (M), the plaintext (M′), and the intermediate variable (S′); and
an output unit configured to output the verification result of the local tag verification unit.
